(19) United States
(12) Patent Application Publication
(10) Pub. No.: US 2009/0270100 A1
(43) Pub. Date: Oct. 29, 2009

(54) RADIO COMMUNICATION TERMINAL DEVICE, NETWORK DEVICE, MOBILE COMMUNICATION SYSTEM, AND POSITION REGISTERING METHOD

(75) Inventors: Akito Fukui, Kanagawa (JP); Takahisa Aoyama, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Matsushita Electric Industrial Co., Ltd., Osaka (JP)

(21) Appl. No.: 12/088,227

(22) PCT Filed: Sep. 27, 2006
(86) PCT No.: PCT/JP2006/319196

§ 371 Date: Mar. 26, 2008

(30) Foreign Application Priority Data
Sep. 28, 2005 (JP) 2005-282986

(51) Int. Cl. H04W 60/00

(52) U.S. Cl. 455/435.2

(57) ABSTRACT

Disclosed are a radio communication terminal device for reducing a power consumption needed for releasing an RRC Connection after a position registration, a network device, a mobile communication system and a position registering method. In this position registering method, in case the RRC state of a UE is in an Idle state at ST501, the UE sets flag=1, whereas the RRC Connection is established between the UE and a UTRAN. The flag set at ST501 is sent at ST504 to the UTRAN, and the flag received by the UTRAN is stored at ST505. At ST507, an RA Update Accept received by the UTRAN is sent to the UE, and the RRC Connection is released in case the value of the flag stored at ST505 is 1. When the UE receives a DOWNLINK DIRECT TRANSFER, on the other hand, the RRC Connection is released in case the value of the flag set at ST501 is 1.

### TECHNICAL FIELD

The present invention relates to a radio communication terminal apparatus, network apparatus, mobile communication system and location registration method that establishes radio channels and executes location registration.

### BACKGROUND ART

Conventionally, a radio access network (“RAN”) is comprised of a radio network controller (“RNC”) and a Node B, where the RNC is connected to the core network (“CN”), which is a switchboard network, via Iu interface, and the Node B is connected to user equipment (“UE”) via radio interface.

FIG. 1 shows a protocol configuration of the control plane of a mobile communication system. In FIG. 1, the UE (User Equipment) provides radio layer 1, radio layer 2, RRC (Radio Resource Control) and NAS (Non Access Stratum). In addition, the UTRAN (UMTS Terrestrial Radio Access Network) provides radio layer 1, radio layer 2, RRC, layer 1, layer 2 and RANAP. Furthermore, the CN (Core Network) provides layer 1, layer 2, RANAP and NAS.

Radio layer 1 performs such as error correction coding, modulation and demodulation and RF processing. Radio layer 2 is divided into two sublayers, Medium Access Control (“MAC”), which controls radio resource allocation and Radio Link Control (“RLC”), which controls radio links. MAC performs multiplexing and demultiplexing processing for transferring data from an upper layer to radio layer 1. On the other hand, an RLC divides and combines data for transferring data from an upper layer to MAC and retransmits data for correcting errors in a radio section.

RRC performs radio resource control, such as setting up and releasing of a control channel, setting up and releasing a data channel, handover and a message transfer from NAS.

NAS performs, for example, location registration, authentication, session control for communications between the UE and the CN. Signaling of NAS is transmitted and received between the UE and the CN via RRC, and RANAP.

RANAP performs control between the UTRAN and the CN, and transfer a NAS message from the UE.

Layer 1 and layer 2 are protocols of wire layer 1 and wire layer 2 between the UTRAN and the CN, and utilize IP (Internet Protocol) and ATM (Asynchronous Transfer Mode).

Here, the steps of general location registration will be explained using FIG. 2. In FIG. 2, in step (hereinafter abbreviated as “ST”) 11, the UE establishes a control channel (i.e. RRC connection) between the UE and the UTRAN, and transmits RRC connection request from the UE to the UTRAN.

In ST12, the UTRAN receives RRC connection request, sets a RRC connection parameter in RRC connection setup and transmits this parameter to the UE.

In ST13, the UE receives RRC connection setup and sets a parameter of RRC connection in radio layer 1 and radio layer 2. Radio layer 1 establishes of radio channel synchronization, and upon being reported the establishment of radio channel synchronization from radio layer 1, the UE transmits an RRC connection setup complete message (hereinafter abbreviated as “RRC connection setup complete”) to the UTRAN.

In this case, in the RRC's of the UE and the UTRAN, the RRC state shifts from idle mode (the state where RRC connection is not established) to connected mode (the state where RRC connection is established), and, the UE and the UTRAN each store the new mode (here, RRC connected mode).

In ST14, the UE receives a location registration request from the NAS, sets a routing area (“RA”) update request in an UPLINK DIRECT TRANSFER message (hereinafter abbreviated as “UPLINK DIRECT TRANSFER”), and transmits the UPLINK DIRECT TRANSFER to the UTRAN. In ST15, the UTRAN receives the UPLINK DIRECT TRANSFER. Then, the UTRAN takes out the RA update request set in the UPLINK DIRECT TRANSFER and transmits the RA update request taken out to the NAS of the CN.

In ST16, the CN performs location registration processing and transmits a location registration response (i.e. “RA update accept”) to the UTRAN via RANAP. In ST17, the UTRAN receives the RA update accept and sets the received RA update accept in a DOWNLINK DIRECT TRANSFER message (hereinafter abbreviated as “DOWNLINK DIRECT TRANSFER”), and transmits the DOWNLINK DIRECT TRANSFER to the UE. Upon receiving the DOWNLINK DIRECT TRANSFER, the UE takes out the set RA update request and transmits the RA update request taken out to the NAS of the UE.

In ST18, the UTRAN transmits an RRC connection release message (hereinafter abbreviated as “RRC connection release”) to the UE so as to release the RRC connection. In ST19, the UE receives the RRC connection release and transmits an RRC connection release complete message (hereinafter abbreviated as “RRC connection release complete”) in response, to the UTRAN. The UE commands radio layer 2 and radio layer 1 to release a radio channel for the RRC connection and releases the RRC connection. Similarly, upon receiving an RRC connection release complete, the UTRAN commands radio layer 2 and radio layer 1 to release the radio channel for RRC connection and releases the RRC connection.

In the RRC's of the UE and UTRAN, the RRC state shifts from RRC connected mode to RRC idle mode, and the shifted RRC idle mode is stored.

By the steps explained above, location registration processing can be performed among the UE, the UTRAN and the CN.
Patent Document 1: Japanese Unexamined Patent Publication No. 2004-526393
Non-patent Document 1: 3GPP TS.25.331 v6.6.0, 3rd Generation Partnership Project; Technical Specification Group Radio Access Network; Radio Resource Control (RRC) protocol specification

### DISCLOSURE OF INVENTION

### Problems to be Solved by the Invention

However, when the UE state is in idle mode, the UE needs to perform location registration in every determined period or every move across location registration areas, and, having performed location registration, the UE needs to release an RRC connection, and therefore there is a problem that power required for transmitting and receiving messages to and from the UTRAN is consumed for releasing the RRC connection.

It is therefore an object of the present invention to provide a radio communication terminal apparatus, network apparatus, mobile communication system and location registration method that make it possible to reduce power consumption required to release RRC connection after location registration.

### Means for Solving the Problem

The radio communication terminal apparatus of the present invention adopts a configuration including: a management section that stores and manages connected mode, in which a radio resource control connection to a network apparatus is established, and idol mode, in which the radio resource control connection to the network apparatus is not established; and a radio resource control protocol processing section that, when a radio resource control connection is established when a state stored and managed in the management section is in idle mode, determines that the radio resource control connection is established to perform location registration, detachment or temporary mobile subscriber identity reallocation between network apparatuses, and releases the radio resource control connection when the location registration, detachment, or temporary mobile subscriber identity reallocation is finished.

The network apparatus of the present invention adopts a configuration including: a network apparatus comprising a radio resource control protocol processing section that, when a radio resource control connection is established to perform location registration, detachment or temporary mobile subscriber identity reallocation to a radio communication terminal apparatus, releases the radio resource control connection when the location registration, detachment, or temporary mobile subscriber identity reallocation is finished.

The mobile communication system of the present invention adopts a configuration including: a mobile communication system comprising a radio communication terminal apparatus, the apparatus comprising: a management section that stores and manages connected mode, in which a radio resource control connection is established, and idle mode, in which a radio resource control connection is not established; and a radio resource control processing section that, when a radio resource control connection is established when a state stored and managed in the management section is in idle mode, determines that the radio resource control connection is established to perform location registration, and transmits to a network apparatus a request for location registration, and a radio resource control release flag which allows the radio resource control connection to be released when the location registration is finished; and the network apparatus that, upon receiving the radio resource control release flag from the radio communication terminal apparatus, releases the radio resource control connection when the location registration is finished.

The mobile communication system of the present invention adopts a configuration including: a management section that stores and manages connected mode, in which a radio resource control connection is established, and idle mode, in which a radio resource control connection is not established; and a radio resource control processing section that, when a radio resource control connection is established to perform location registration when a state stored and managed in the management section is in idle mode, determines that the radio resource control connection is established to perform location registration, sets information showing whether or not the radio resource control connection is allowed to be released when the location registration is finished, in an establishment cause included in a radio resource control connection request which requests the radio resource control connection, and transmits the radio resource control connection request to a network apparatus; and the network apparatus that, upon receiving the establishment cause from the radio communication terminal apparatus, releases the radio resource control connection when the location registration is finished.

The location registration method of the present invention including: when a radio resource control connection is established to perform location registration, detachment or temporary mobile subscriber identity reallocation between a radio communication terminal apparatus and a network apparatus, each of the radio communication terminal apparatus and the network apparatus releases the radio resource control connection when the location registration, detachment, or temporary mobile subscriber identity reallocation is finished.

### Advantageous Effect of the Invention

According to the present invention, it is possible to reduce power consumption required to release an RRC connection after location registration.

### BRIEF DESCRIPTION OF DRAWINGS

FIG. 1 illustrates a protocol configuration of the control plane in a mobile communication system;

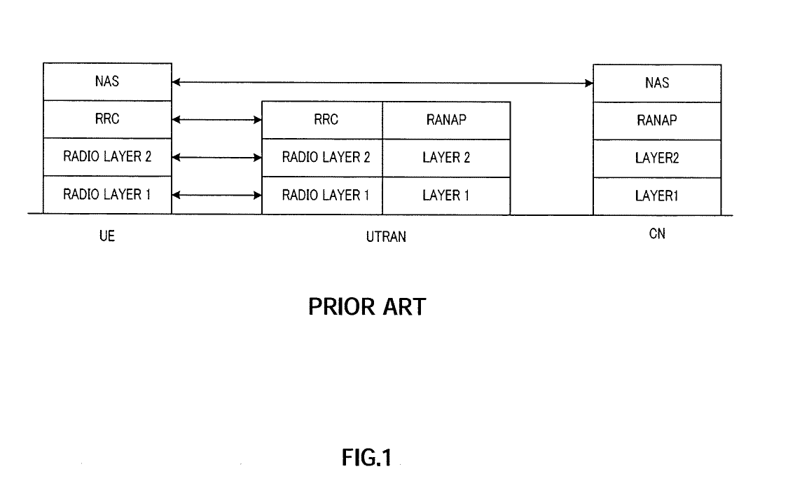

FIG. 2 is a sequence diagram showing the general steps of location registration;

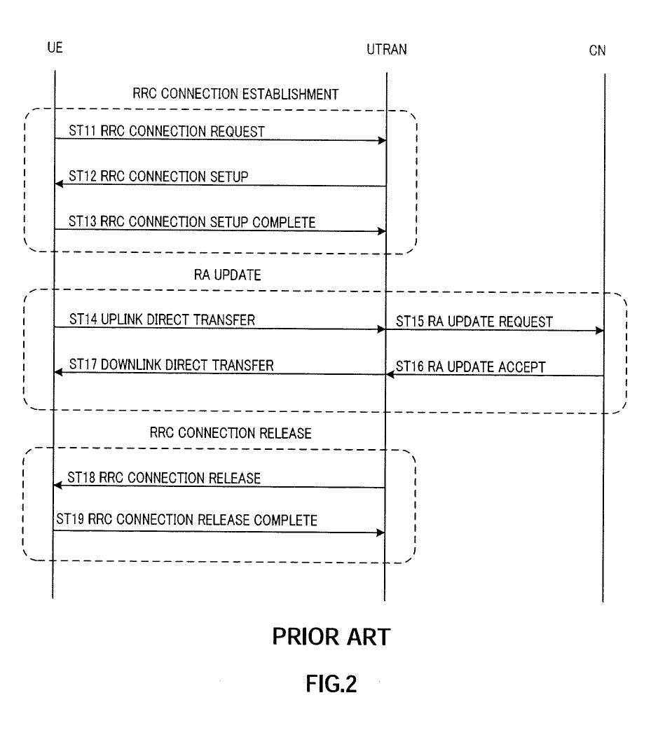

FIG. 3 is a block diagram showing the configuration of the RRC of the UE and the UTRAN, according to Embodiment 1 of the present invention;

FIG. 4 is a flowchart showing the location registration steps in the RRC protocol processing section of the UE shown in FIG. 3;

FIG. 5 shows a configuration of the UPLINK DIRECT TRANSFER;

FIG. 6 is a flowchart showing the steps of location registration in the RRC protocol processing section of the UTRAN shown in FIG. 3;

FIG. 7 is a sequence diagram showing the steps of location registration processing among the UE, the UTRAN and CN according to Embodiment 1 of the present invention;

FIG. 8 is a block diagram showing the configuration of the RRC of the UE and the UTRAN, according to Embodiment 2 of the present invention;

FIG. 9 shows various types of establishment causes;

FIG. 10 is a flowchart showing the steps of location registration in the RRC protocol processing section of the UE shown in FIG. 8;

FIG. 11 shows a configuration of the RRC connection request;

FIG. 12 is a flowchart showing the steps of location registration in the RRC protocol processing section of the UTRAN shown in FIG. 8;

FIG. 13 is a sequence diagram showing the steps of location registration processing among the UE, the UTRAN and the CN according to Embodiment 2 of the present invention;

FIG. 14 is a block diagram showing the configuration of the RRC of the UE and the UTRAN, according to Embodiment 3 of the present invention;

FIG. 15 is a flowchart showing the steps of location registration in the RRC protocol processing section of the UE shown in FIG. 14;

FIG. 16 is a flowchart showing the steps of location registration in the RRC protocol processing section of the UTRAN shown in FIG. 14;

FIG. 17 shows a configuration of the DOWNLINK DIRECT TRANSFER; and

FIG. 18 is a sequence diagram showing the steps of location registration processing among the UE, the UTRAN and the CN according to Embodiment 3 of the present invention.

### BEST MODE FOR CARRYING OUT THE INVENTION

Embodiments of the present invention will be described in detail below using the accompanying drawings.

### Embodiment 1

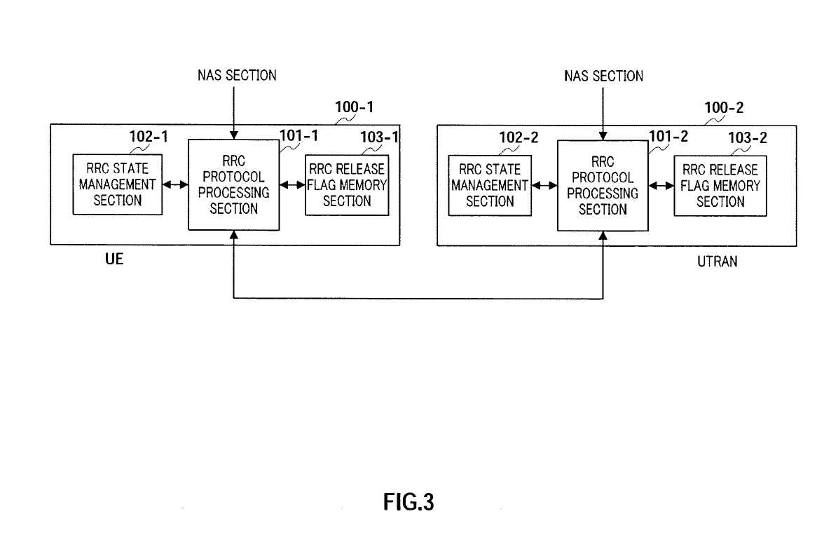

FIG. 3 is a block diagram showing the configuration of the RRC of the UE and the UTRAN, according to Embodiment 1 of the present invention. In this figure, RRC protocol processing sections 101-1 and 101-2 perform protocol processing including setting up and releasing RRC connections and executing location registration processing between the UE and the UTRAN.

RRC state management sections 102-1 and 102-2 manage as to whether the RRC state is in idle mode (the state where RRC connection is not established) or in connected mode (the state where RRC connection is established).

When RRC idle mode is stored in RRC state management sections 102-1 and 102-2, RRC release flag memory sections 103-1 and 103-2 execute an RRC release message (hereinafter abbreviated as “RRC release”) after location registration, and consequently, RRC release flag=1 is stored. In addition, when RRC connected mode is stored in RRC state management sections 102-1 and 102-2, an RRC connection has already been established for communications other than location registration, which makes it no longer necessary to establish an RRC connection, and, in addition, the RRC release is not allowed after location registration, and consequently, RRC release flag=0 is stored.

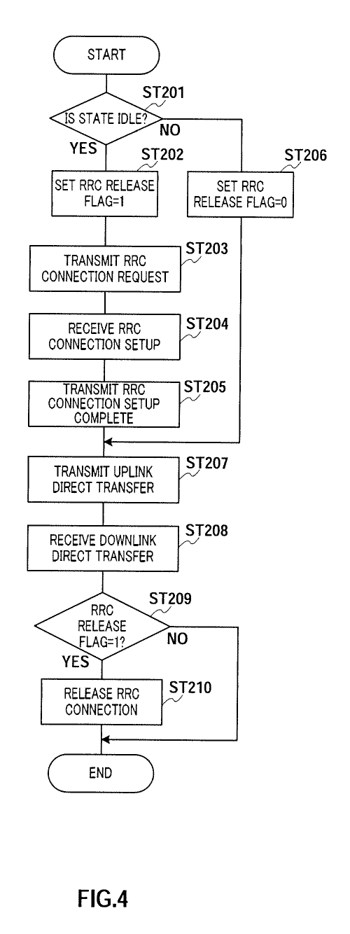

Next, the steps of location registration in RRC protocol processing section 101-1 of the UE will be explained using FIG. 4. In FIG. 4, in step (hereinafter abbreviated as “ST”) 201, the RRC state managed by RRC state management section 102-1 is checked to decide whether or not the managed RRC state is idle mode. If the state is idle mode (“YES”), the step moves to ST202, and, if the state is connected mode (“NO”), instead of idle mode, the step moves to ST206.

In ST202, to execute RRC release after location registration, RRC release flag=1 is set and stored in RRC release flag memory section 103-1. In ST203, an RRC connection request is transmitted to the UTRAN.

In ST204, an RRC connection setup message (hereinafter abbreviated as “RRC connection setup”) is received from the UTRAN, and, in ST205, an RRC connection setup complete is transmitted to the UTRAN.

In ST206, RRC connection has already established for communications other than location registration, which makes it no longer necessary to establish an RRC connection, and, in addition, the RRC release is not allowed after location registration, and consequently, RRC release flag=0 is set, and stored in RRC release flag memory section 103-1.

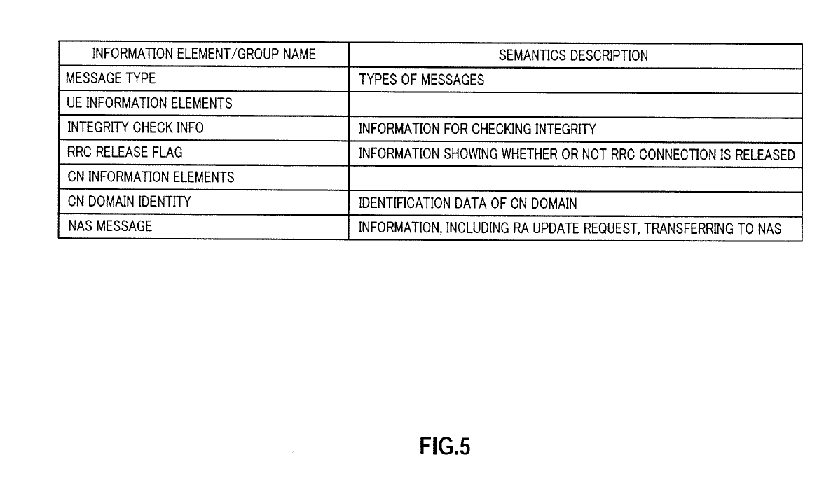

In ST207, an RA update request received from the NAS section and the RRC release flag stored in RRC release flag memory section 103-1 are set in an UPLINK DIRECT TRANSFER and transmitted to the UTRAN. For reference, FIG. 5 shows the configuration of the UPLINK DIRECT TRANSFER. As shown in FIG. 5, the UPLINK DIRECT TRANSFER includes integrity check info, RRC release flag, CN domain identity and NAS message.

In ST208, a DOWNLINK DIRECT TRANSFER is received from the UTRAN, and, in ST209, the value of the RRC release flag stored in RRC release flag memory section 103-1 is checked to determine whether or not the RRC release flag is 1. If the RRC release flag is 1 (“YES”), the step moves to ST210, and, if the RRC release flag is not 1 and is 0 (“NO”), the location registration processing is finished.

In ST210, RRC protocol processing section 101-1 of the UE commands a release of RRC connection to radio layer 1 and radio layer 2, and radio layer 1 and radio layer 2 release RRC connection without receiving RRC connection release message.

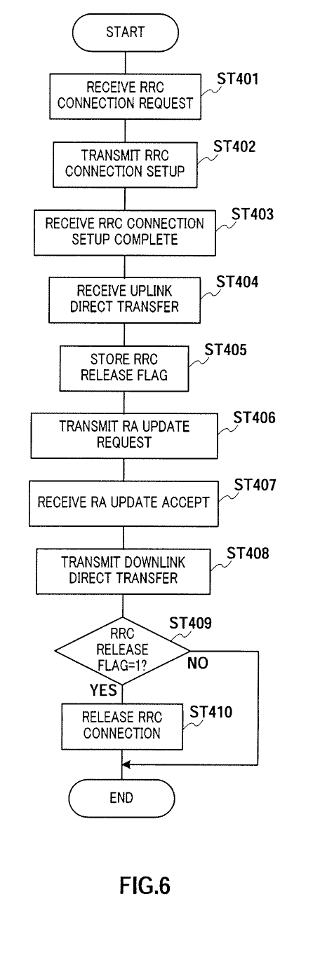

Next, the steps of location registration in RRC protocol processing section 101-2 of the UTRAN will be explained using FIG. 6. In FIG. 6, in ST401, an RRC connection request is received from the UE, and, in ST402, an RRC connection setup is transmitted to the UE.

In ST403, an RRC connection setup complete is received from the UE, and an RRC connection is set up between the UE and the UTRAN.

In ST404, the UPLINK DIRECT TRANSFER is received from the UE, and, in ST405, the RRC release flag set in the received UPLINK DIRECT TRANSFER is taken out, the RRC release flag taken out is stored in RRC release flag memory section 103-2. Furthermore, in ST406, the RA update request set in the received UPLINK DIRECT TRANSFER is taken out and transmitted to the CN via RANAP. In this connection, upon receiving an RA update request, the CN performs location registration and transmits an RA update accept in response, to the UTRAN via RANAP.

In ST407, the RA update accept is received from the CN, and, in ST408, the received RA update accept is set in the DOWNLINK DIRECT TRANSFER and transmitted to the UE.

In ST409, the value of the RRC release flag stored in RRC release flag memory section 103-2 is checked to decide whether or not the RRC release flag is 1. If the RRC release flag is 1 (“YES”), the step moves to ST410, and, if the RRC release flag is not 1 but is 0 (“NO”), the location registration processing is finished.

In ST410, RRC protocol processing section 101-2 of the UTRAN commands radio layer 1 and radio layer 2 to release RRC connection, and radio layer 1 and radio layer 2 release RRC connection without receiving RRC connection release message.

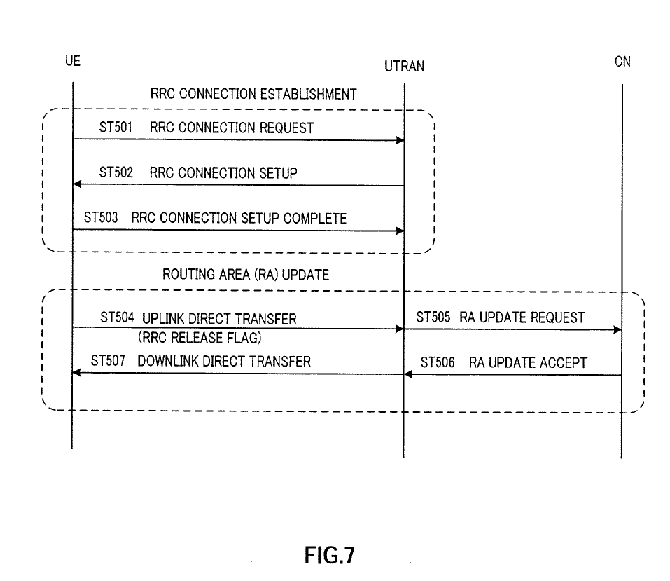

Next, the steps of location registration processing among the UE, the UTRAN and the CN, will be explained using FIG. 7. In FIG. 7, in ST501, RRC protocol processing section 101-1 of the UE checks the RRC state stored in RRC state management section 102-1. An RRC release flag=1 is set, assuming that the RRC state is idle mode, and is stored in RRC release flag memory section 103-1. Then the RRC connection request is transmitted to the UTRAN from the UE.

In ST502, the UTRAN receives the RRC connection request from the UE and transmits the RRC connection setup to the UE.

In ST503, the UE receives the RRC connection setup from the UTRAN and the UE transmits the RRC connection setup complete to the UTRAN. When the UTRAN receives the RRC connection setup complete, RRC connection is set up between the UE and the UTRAN.

In ST504, the RA update request received by the UE from the NAS section and the RRC release flag stored in RRC release flag memory section 103-1 are set in the UPLINK DIRECT TRANSFER and transmitted to the UTRAN.

In ST505, the UTRAN receives the UPLINK DIRECT TRANSFER from the UE, takes out the RRC release flag set in the received UPLINK DIRECT TRANSFER and stores the RRC release flag taken out in RRC release flag memory section 103-2. In addition, the UTRAN takes out the RA update request set in the UPLINK DIRECT TRANSFER received by the UTRAN and transmits the RA update request taken out to the CN via RANAP.

In ST506, the CN receives the RA update request from the UTRAN, performs location registration and transmits an RA update accept in response, to the UTRAN via RANAP.

In ST507, the UTRAN receives the RA update accept from the CN, sets the received RA update accept in the DOWNLINK DIRECT TRANSFER, and transmits the DOWNLINK DIRECT TRANSFER to the UE. In addition, the UTRAN checks the value of the RRC release flag stored in RRC release flag memory section 103-2, if the RRC release flag is 1, the UTRAN commands radio layer 1 and radio layer 2 to release the RRC connection, and radio layer 1 and radio layer 2 release the RRC connection without transmitting an RRC connection release message. On the other hand, when the UE receives the DOWNLINK DIRECT TRANSFER from the UTRAN, the UE checks the value of the RRC release flag stored in RRC release flag memory section 103-1, if the RRC release flag is 1, commands radio layer 1 and radio layer 2 to release of the RRC connection and radio layer 1 and radio layer 2 release the RRC connection without receiving an RRC connection release message.

In this way, according to Embodiment 1, when an RRC connection is established to perform location registration between the UE and the UTRAN, an RRC release flag, which allows release of the RRC connection when the location registration is finished, is set in UPLINK DIRECT TRANSFER by the UE and transmitted to the UTRAN, so that it is possible to release an RRC connection without processing of transmitting and receiving an RRC connection release message between the UE and the UTRAN, and, consequently, reduce power consumption required to receive and transmit the RRC connection release message.

### Embodiment 2

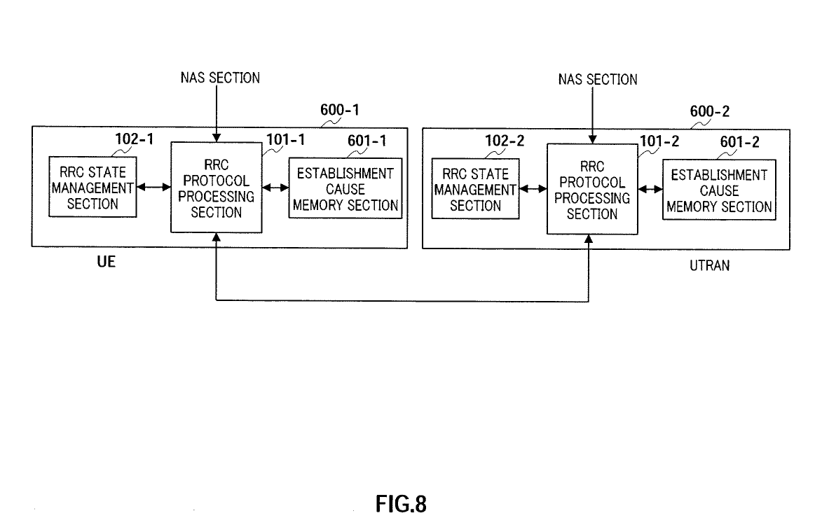

FIG. 8 is a block diagram showing the configuration of the RRC of the UE and the UTRAN, according to Embodiment 2 of the present invention. However, in FIG. 8 the same reference numerals are assigned to the same parts in FIG. 3, and description thereof in detail will be omitted.

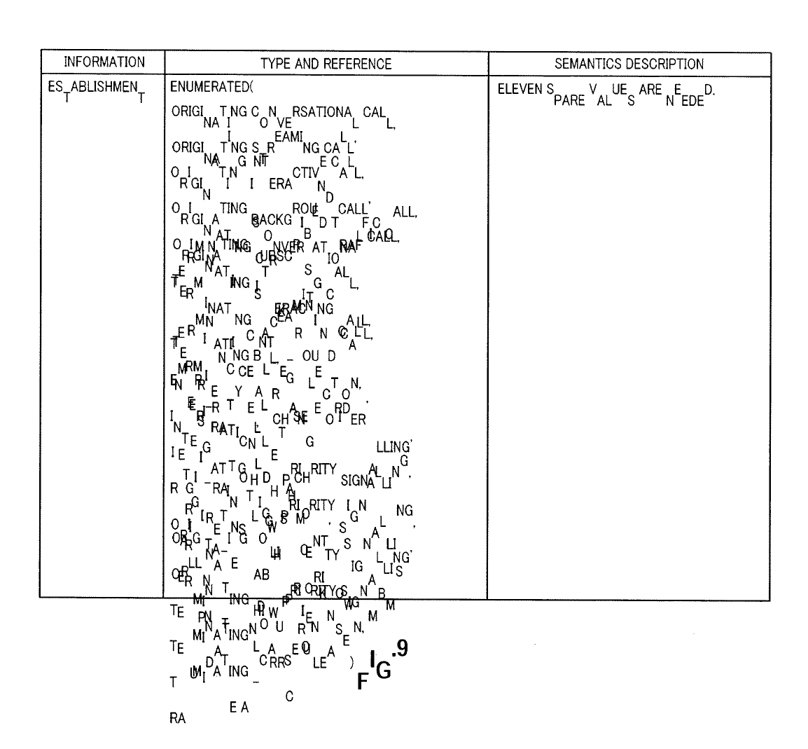

In FIG. 8, when the RRC idle state is stored in RRC state management sections 102-1 and 102-2, establishment cause memory sections 601-1 and 601-2 execute RRC release after location registration, and consequently, an RA update & RRC release message (hereinafter abbreviated as “RA update & RRC release”)newly established as an establishment cause is stored. Moreover, when RRC connected mode is stored in RRC state management sections 102-1 and 102-2, an RRC connection has already been established for communications other than location registration, which makes it no longer necessary to establish an RRC connection, and, in addition, the RRC release is not allowed after location registration, and consequently, invalid is stored as an establishment cause. In addition, as shown in FIG. 9, establishment causes have various types of information.

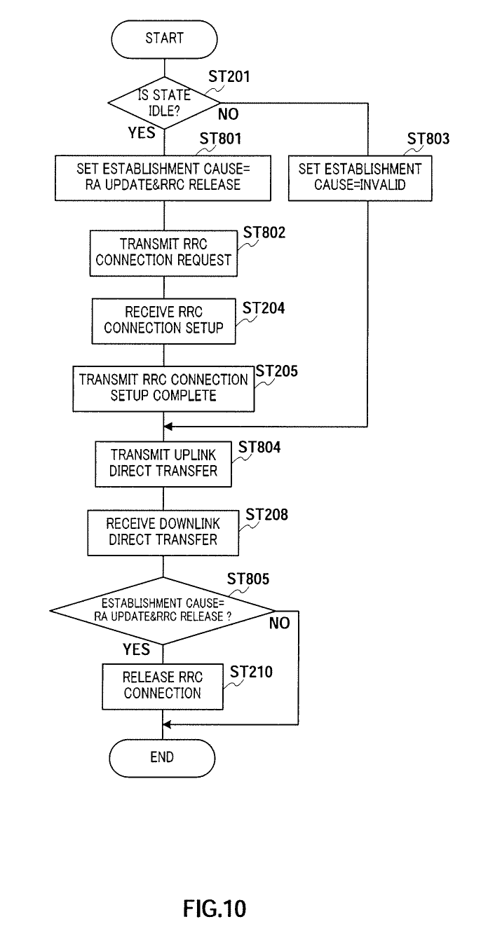

Next, the steps of location registration in RRC protocol processing section 101-1 of the UE will be explained using FIG. 10. However, in FIG. 10 the same reference numerals are assigned to the same parts in FIG. 4, and description thereof in detail will be omitted. In FIG. 10, in ST801, it is determined that the RRC state managed by RRC state management section 102-1 is idle mode in ST201, an RRC release is executed after location registration, and consequently, an RA update & RRC release is set in an establishment cause and stored in an establishment cause memory section 601-1.

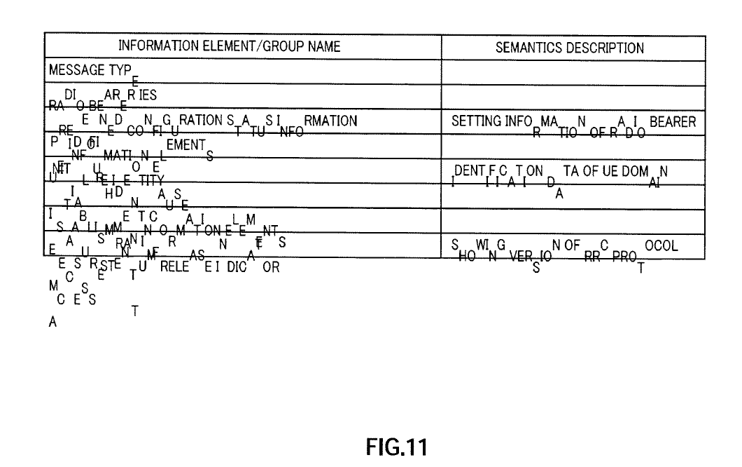

In ST802, the value of the establishment cause set in ST801, is set in an RRC connection request and transmitted to the UTRAN. For reference, FIG. 11 shows the configuration of an RRC connection request. As shown in FIG. 11, an RRC connection request includes predefined configuration status information, initial UE identity, establishment cause and access stratum release indicator.

In ST803, it is determined that the RRC state managed by RRC state management section 102-1 is in connected mode in ST201, an RRC connection has already been established for communications other than location registration, which makes it no longer necessary to establish an RRC connection, and, in addition, the RRC release is not allowed after location registration, and consequently, invalid is set in an establishment cause and stored in establishment cause memory section 601-1.

In ST804, an RA update request received from the NAS section is set in an UPLINK DIRECT TRANSFER, and transmitted to the UTRAN.

In ST805, the value of the establishment cause stored in establishment cause memory section 601-1 is checked to determine whether or not the establishment cause is RA update & RRC release. If the establishment cause is RA update & RRC release (“YES”), the step moves to ST210, and, if the establishment cause is not an RA update & RRC release and is invalid (“NO”), the location registration processing is finished.

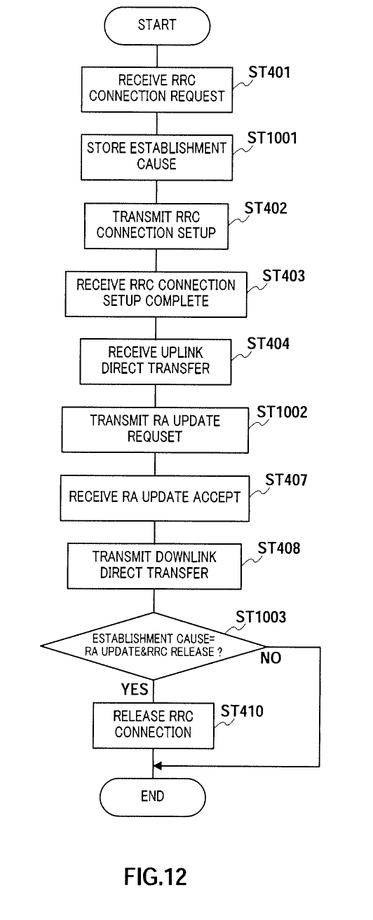

Next, the steps of location registration in RRC protocol processing section 101-2 of the UTRAN will be explained using FIG. 12. However, in FIG. 12 the same reference numerals are assigned to the same parts in FIG. 6, and description thereof in detail will be omitted. In FIG. 12, in ST1001, the establishment cause set in the RRC connection request received in ST401 is taken out and the establishment cause taken out is stored in establishment cause memory section 601-2.

In ST1002, the RA update request set in the UPLINK DIRECT TRANSFER received in ST404 is taken out and transmitted to the CN via RANAP.

In ST1003, the value of the establishment cause stored in establishment cause memory section 601-2 is checked to decide whether or not the establishment cause is an RA update & RRC release. If the establishment cause is RA update & RRC release (“YES”), the step moves to ST410, and, if the establishment cause is not RA update & RRC release and is invalid (“NO”), the location registration processing is finished.

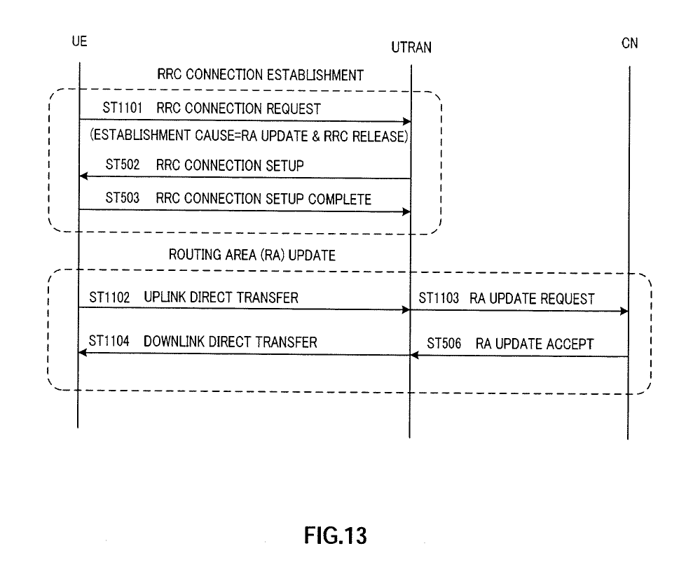

Next, the steps of location registration processing among the UE, the UTRAN and the CN, will be explained using FIG. 13. However, in FIG. 13 the same reference numerals a reassigned to the same parts in FIG. 7, and description thereof in detail will be omitted. In FIG. 13, in ST1101, RRC protocol processing section 101-1 of the UE checks the RRC state stored in RRC state management section 102-1. An establishment cause=RA update & RRC release is set, assuming that the RRC state is in idle mode, and stored in establishment cause memory section 601-1. Then the value of the establishment cause is set in the RRC connection request and transmitted to the UTRAN.

In ST1102, the RA update request received by the UE from the NAS section is set in the UPLINK DIRECT TRANSFER, and transmitted to the UTRAN.

In ST1103, the UTRAN receives the UPLINK DIRECT TRANSFER from the UE, takes out the RA update request set in the received UPLINK DIRECT TRANSFER and transmits the RA update request taken out to the CN via RANAP.

In ST1104, the UTRAN receives the RA update accept from the CN, sets the received RA update accept in the DOWNLINK DIRECT TRANSFER, and transmits the DOWNLINK DIRECT TRANSFER to the UE. In addition, the UTRAN checks the value of the establishment cause stored in establishment cause memory section 601-2, if the establishment cause is RA update & RRC release, the UTRAN commands radio layer 1 and radio layer 2 to release the RRC connection, and radio layer 1 and radio layer 2 release the RRC connection without transmitting RRC connection release message. On the other hand, when the UE receives the DOWNLINK DIRECT TRANSFER from the UTRAN, the UE checks the value of the establishment cause stored in establishment cause memory section 601-1, if the establishment cause is RA update & RRC release, commands radio layer 1 and radio layer 2 to release the RRC connection and radio layer 1 and radio layer 2 release the RRC connection without receiving RRC connection release message.

In this way, according to Embodiment 2, when an RRC connection is established to perform location registration between the UE and the UTRAN, an establishment cause, which allows release of the RRC connection when the location registration is finished, is set in an RRC connection request by the UE and transmitted to the UTRAN, so that it is possible to release an RRC connection without processing of transmitting and receiving an RRC connection release message between the UE and the UTRAN after location registration, and, consequently, reduce power consumption required to receive and transmit the RRC connection release message.

### Embodiment 3

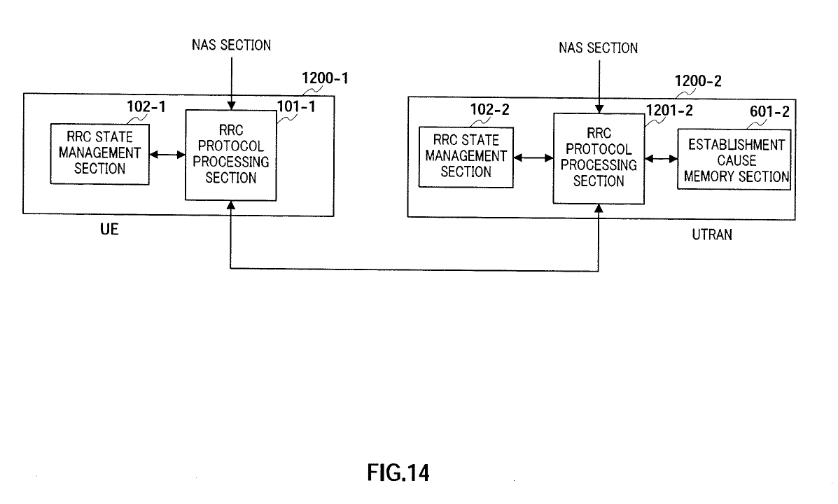

FIG. 14 is a block diagram showing the configuration of the RRC of the UE and the UTRAN, according to Embodiment 3 of the present invention. However, in the configuration of the RRC of the UE and the UTRAN shown in FIG. 8, establishment cause memory section 601-1 of the UE is removed in FIG. 14, and so the same reference numerals are assigned to the same parts in FIG. 8, and description thereof in detail will be omitted.

In FIG. 14, establishment cause memory section 601-2 stores an establishment cause transmitted from the UE depending on the RRC state of the UE. That is, when the RRC state of the UE is in idle mode, establishment cause=RA update & RRC release is stored, and, when the RRC state of the UE is in connected mode, establishment cause invalid is stored.

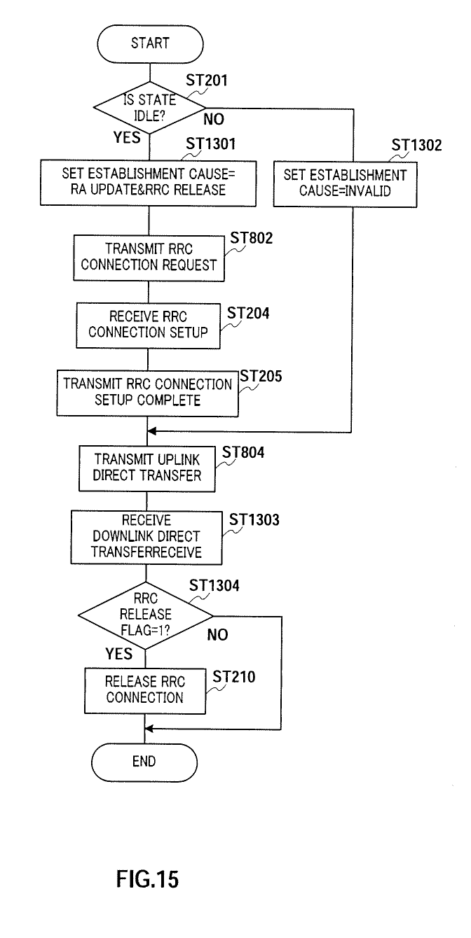

Next, the steps of location registration in RRC protocol processing section 101-1 of the UE will be explained using FIG. 15. However, in FIG. 15 the same reference numerals a reassigned to the same parts in FIG. 10, and description thereof in detail will be omitted. In FIG. 15, in ST1301, it is determined that the RRC state managed by RRC state management section 102-1 is idle mode in ST201, RRC Release is executed after location registration, and consequently, an RA update & RRC release is set in an establishment cause. The processing to be explained here differs from the processing shown in FIG. 10, and the set establishment cause is not stored.

In ST1302, it is determined that the RRC state managed by RRC state management section 102-1 is connected mode in ST201, an RRC connection has already been established for communications other than location registration, which makes it no longer necessary to establish an RRC connection, and, in addition, the RRC release is not allowed after location registration, and consequently, invalid is set in an establishment cause. This is different from the processing shown in FIG. 10, in that the set establishment cause is not stored.

In ST1303, the DOWNLINK DIRECT TRANSFER in which an RRC release flag is set, is received from the UTRAN, and, in ST1304, the RRC release flag is taken out from the DOWNLINK DIRECT TRANSFER received in ST1303 and it is determined whether or not the value of the RRC release flag taken out is RRC release flag=1. If the RRC release flag is 1 (“YES”), the step moves to ST210, and, if the RRC release flag is not 1 and is 0 (“NO”), location registration processing is finished.

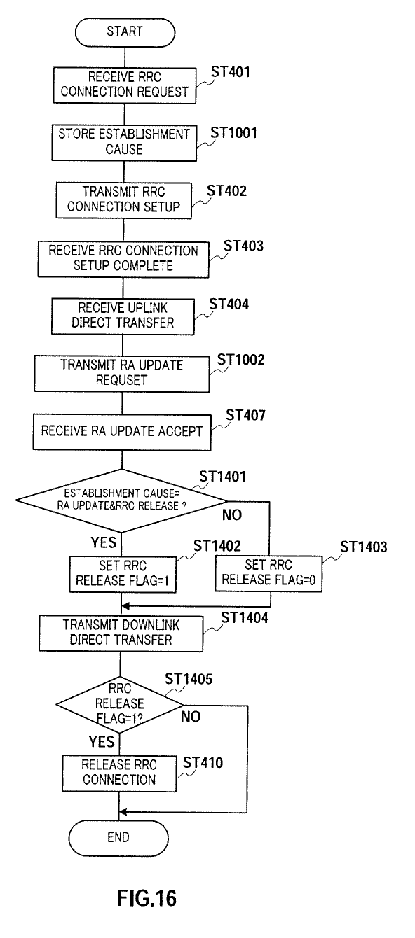

Next, the steps of location registration in RRC protocol processing section 1201-2 of the UTRAN will be explained using FIG. 16. However, in FIG. 16 the same reference numerals are assigned to the same parts in FIG. 12, and description thereof in detail will be omitted. In FIG. 16, in ST1401, the value of the establishment cause stored in establish cause memory section 601-2 is checked to decide whether or not the establishment cause is RA update & RRC release. If the establishment cause is RA update & RRC release (“YES”), the step moves to ST1402, and, if the establishment cause is not RA update & RRC release and is invalid (“NO”), the step moves to ST1403.

In ST1402, RRC release flag=1 is set, and, in ST1403, RRC release flag=0 is set.

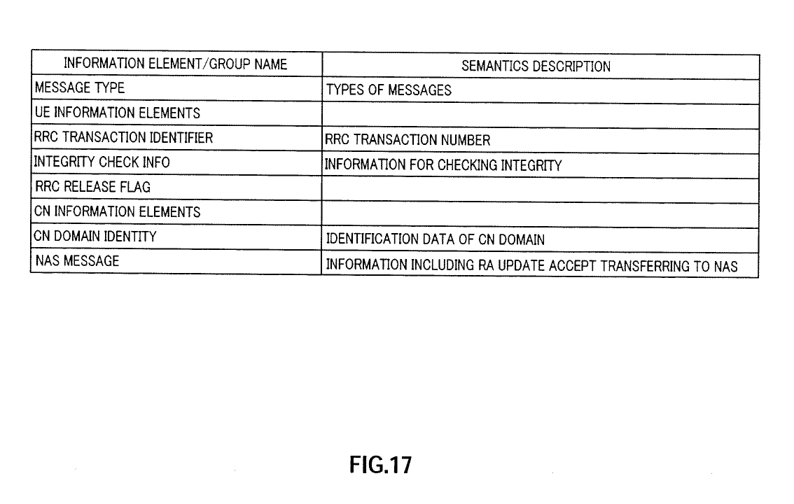

In ST1404, the RA update accept received in ST407 and the RRC release flag set in ST1402 or ST1403 are set in the DOWNLINK DIRECT TRANSFER and transmitted to the UE. For reference, FIG. 17 shows the configuration of the DOWNLINK DIRECT TRANSFER. As shown in FIG. 17, the DOWNLINK DIRECT TRANSFER includes RRC transaction identifier, integrity check info, RRC release flag, CN domain identity, and NAS message.

In ST1405, the value of the RRC release flag set in ST1402 or ST1403 is checked to decide whether or not RRC release flag is 1. If the RRC release flag is 1 (“YES”), the step moves to ST410, and, if the RRC release flag is not 1 and is 0 (“NO”), the location registration processing is finished.

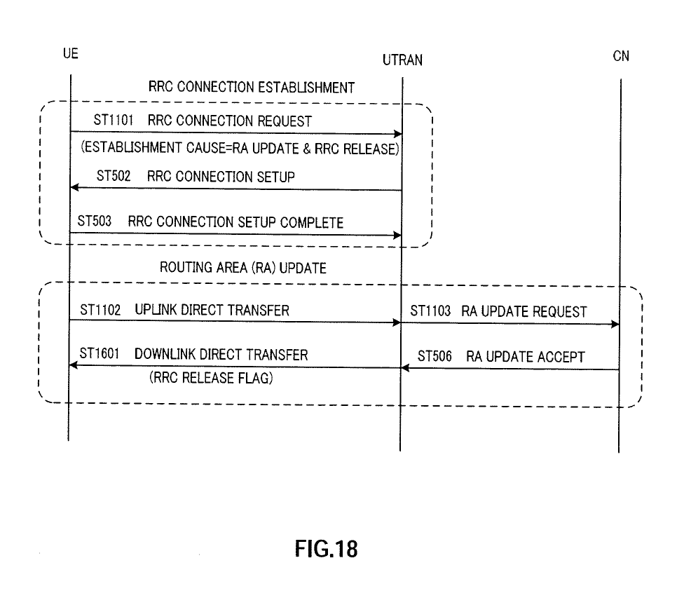

Next, the steps of location registration processing among the UE, the UTRAN and the CN, will be explained using FIG. 18. However, in FIG. 18 the same reference numerals are assigned to the same parts in FIG. 13, and description thereof in detail will be omitted.

In FIG. 18, in ST1601, the UTRAN receives an RA update accept from the CN. In addition, the value of the establishment cause stored in establishment cause memory section 601-2 is checked, and, if the establishment cause is an RA update & RRC release, RRC release flag=1 is set, and, if the establishment cause is invalid, RRC release flag=0 is set. Then, the set RRC release flag and the RA update accept received from the CN are set in the DOWNLINK DIRECT TRANSFER and transmitted to the UE.

Here, the UTRAN checks the value of the set RRC release flag, and if the RRC release flag is 1, commands radio layer 1 and radio layer 2 to release the RRC connection, and radio layer 1 and radio layer 2 release the RRC connection without transmitting the RRC connection release message. On the other hand, if the RRC release flag is 0, location registration processing is finished.

Upon receiving the DOWNLINK DIRECT TRANSFER from the UTRAN, the UE takes out the RRC release flag from the DOWNLINK DIRECT TRANSFER, checks the value of the RRC release flag taken out, if the RRC release flag is 1, commands radio layer 1 and radio layer 2 to release the RRC connection and radio layer 1 and radio layer 2 releases the RRC connection without receiving RRC connection release message. On the other hand, if the RRC release flag is 0, the location registration processing is finished.

In this way, according to Embodiment 3, when an RRC connection is established to perform location registration between the UE and the UTRAN, an establishment cause which allows release of the RRC connection when location registration is finished, is set in RRC connection request by the UE and transmitted to the UTRAN, and, an RRC release flag, which allows release of the RRC connection, is set in DOWNLINK DIRECT TRANSFER by the UTRAN and transmitted to the UE, so that it is possible to release an RRC connection without processing of transmitting and receiving an RRC connection release message between the UE and the UTRAN, thereby reducing power consumption required to receive and transmit RRC connection release messages.

Moreover, although cases have been described with the above embodiments where the UTRAN is explained as an example, the present invention is not limited to this, and Node B, RNC (Radio Network Controller), SGSN or GGSN may be applicable for example, and these are generally referred to as a “network apparatus.”

Moreover, although cases have been described with the above embodiments where RRC connection release processing or RRC connection release complete processing is not performed, RRC connection release processing may be performed and RRC connection release complete processing may not be performed.

Moreover, although cases have been described with the above embodiments where location registration is explained, it may also be applicable to detachment and TMSI reallocation.

In addition, when RRC connection is released, a timer may be set in advance, and, when the timer is expired, RRC connection may be released.

Moreover, although with the above embodiments cases have been described where the present invention is configured by hardware, the present invention may be implemented by software.

Each function block employed in the description of the aforementioned embodiment may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The present application is based on Japanese Patent Application No. 2005-282986, filed on Sep. 28, 2005, the entire content of which is expressly incorporated by reference herein.

### INDUSTRIAL APPLICABILITY

The radio communication terminal apparatus, network apparatus, mobile communication system and location registration method of the present invention can reduce power consumption required to release an RRC connection after location registration of UE and is applicable to, for example, 3GPP radio communication methods.

1. A radio communication terminal apparatus comprising:
a management section that stores and manages connected mode, in which a radio resource control connection to a network apparatus is established, and idol mode, in which the radio resource control connection to the network apparatus is not established; and
a radio resource control protocol processing section that, when a radio resource control connection is established when a state stored and managed in the management section is in idle mode, determines that the radio resource control connection is established to perform location registration, detachment or temporary mobile subscriber identity reallocation between network apparatuses, and releases the radio resource control connection when the location registration, detachment, or temporary mobile subscriber identity reallocation is finished.

2. The radio communication terminal apparatus according to claim 1, wherein the radio resource control protocol processing section transmits to the network apparatus a request for location registration and a radio resource control release flag showing whether or not the radio resource control connection is allowed to be released when the location registration is finished.

3. The radio communication terminal apparatus according to claim 1, wherein, in accordance with a state stored and managed by the management section, the radio resource control protocol processing section sets information showing whether or not the radio resource control connection is allowed to be released when the location registration is finished, in an establishment cause included in a radio resource control connection request which requests the radio resource control connection, and transmits to the network apparatus the radio resource control request.

4. A network apparatus comprising a radio resource control protocol processing section that, when a radio resource control connection is established to perform location registration, detachment or temporary mobile subscriber identity reallocation to a radio communication terminal apparatus, releases the radio resource control connection when the location registration, detachment, or temporary mobile subscriber identity reallocation is finished.

5. The network apparatus according to claim 4, wherein, when the radio resource control protocol processing section receives from the radio communication terminal apparatus a radio resource control release flag which allows the radio resource control connection to be released when the location registration, detachment, or temporary mobile subscriber identity reallocation is finished, the radio resource control protocol processing section releases the radio resource control connection when the location registration, detachment, or temporary mobile subscriber identity reallocation is finished.

6. The network apparatus according to claim 4, wherein, when the radio resource control protocol processing section receives from the radio communication terminal apparatus an establishment cause setting information which allows the radio resource control connection to be released when the location registration, detachment, or temporary mobile subscriber identity reallocation is finished, the radio resource control protocol processing section releases the radio resource control connection when the location registration, detachment, or temporary mobile subscriber identity reallocation is finished.

7. The network apparatus according to claim 6, wherein, when the radio resource control protocol processing section receives from the radio communication terminal apparatus an establishment cause setting information which allows the radio resource control connection to be released when the location registration, detachment, or temporary mobile subscriber identity reallocation is finished, the radio resource control protocol processing section transmits to the radio communication terminal apparatus a radio resource control release flag which allows the radio resource control connection to be released when the location registration, detachment, or temporary mobile subscriber identity reallocation is finished.

8. A mobile communication system comprising a radio communication terminal apparatus, the apparatus comprising:
a management section that stores and manages connected mode, in which a radio resource control connection is established, and idle mode, in which a radio resource control connection is not established; and
a radio resource control processing section that, when a radio resource control connection is established when a state stored and managed in the management section is in idle mode, determines that the radio resource control connection is established to perform location registration, and transmits to a network apparatus a request for location registration, and a radio resource control release flag which allows the radio resource control connection to be released when the location registration is finished; and
the network apparatus that, upon receiving the radio resource control release flag from the radio communication terminal apparatus, releases the radio resource control connection when the location registration is finished.

9. A mobile communication system comprising a radio communication terminal apparatus, the apparatus comprising:
a management section that stores and manages connected mode, in which a radio resource control connection is established, and idle mode, in which a radio resource control connection is not established; and
a radio resource control processing section that, when a radio resource control connection is established to perform location registration when a state stored and managed in the management section is in idle mode, determines that the radio resource control connection is established to perform location registration, sets information showing whether or not the radio resource control connection is allowed to be released when the location registration is finished, in an establishment cause included in a radio resource control connection request which requests the radio resource control connection, and transmits the radio resource control connection request to a network apparatus; and
the network apparatus that, upon receiving the establishment cause from the radio communication terminal apparatus, releases the radio resource control connection when the location registration is finished.

10. A location registration method wherein, when a radio resource control connection is established to perform location registration, detachment or temporary mobile subscriber identity reallocation between a radio communication terminal apparatus and a network apparatus, each of the radio communication terminal apparatus and the network apparatus releases the radio resource control connection when the location registration, detachment, or temporary mobile subscriber identity reallocation is finished.
